(19) United States
(12) Patent Application Publication
(10) Pub. No.: US 2012/0086638 A1
(43) Pub. Date: Apr. 12, 2012

(54) Multi-area handwriting input system and method thereof

(75) Inventors: Chaucer Chiu, Taipei (TW); Huchen Xu, Shanghai (CN)

(73) Assignee: INVENTEC CORPORATION, Taipei (TW)

(21) Appl. No.: 12/928,595

(22) Filed: Dec. 14, 2010

(30) Foreign Application Priority Data
Oct. 12, 2010 (TW) 099134671

(51) Int. Cl. G06K 9/00; G06F 3/033

(52) U.S. Cl. 345/163; 382/189

(57) ABSTRACT

A multi-area handwriting input system and a method thereof are provided. The system and the method provide multiple input areas and one candidate words display area in a display interface. When a first handwritten trail is entered in the first input area, if the user does not select any of the first candidate words as the input, then the system and the method will determine whether any of the second candidate words identified from the second handwritten trail in the second input area can be combined with any of the first candidate words. If such a combination is found, then the invention displays the combined words in the candidate words display area for selection. If not, then the invention temporarily uses the first candidate word with the highest priority in display order number as an input word and displays the second candidate words for selection. Therefore, the system and method thereof can enhance the efficiency of handwritten word identification.

### BACKGROUND OF THE INVENTION

1. Field of Invention

The invention relates to a handwriting input system and the method thereof. In particular, the invention relates to a multi-area handwriting input system that receives handwritten trails in multiple input areas separately and determines possible combinations of words for selection. The invention also disclosed the method thereof.

2. Related Art

Touch control is a control mechanism that, when a finger touches the sensor, the analog signals is then converted into digital signals and being sent to a computer for further processing. This mechanism is widely used in various handheld devices, touch-control panels, and other electronic devices. With the advance in touch-control technology and wider the applications grows, handwriting input method has become an important topic among the developers.

In the conventional handwriting input method, one feature is that a single area is used as the basic unit for input recognition. After a user enters a handwritten trail, a computer is used to execute handwriting recognition and generate candidate words for the user to select as the final input. In the handwriting input method of using a single area as the input area, it can be further divided into single-area single-word recognition and single-area multi-word recognition.

The single-area single-word recognition means that each time the input handwritten trail is treated as the input of one word. So even if the user enters two words at a time, it is still taken as a single word in the recognition. If one wants to enter multiple words, the next word can be entered only after the current handwritten trail is recognized, thus leads to a decrease in the smoothness of entering words. While single-area single-word recognition exist certain shortcoming, single-area multi-word recognition allows the user to input multiple words in the same area at a time, where additionally, the system can perform handwriting recognition for multiple words as well. Although single-area multi-word recognition improves the smoothness in input by accepting multiple trails before determining candidate words, it is sometimes difficult to distinguish one handwritten trail from another when multiple handwritten trails were put altogether, thus results in that during the recognition process a single word may be recognized as multiple words or vice versa. Thus, the produced candidate words are often not what the user wants. It greatly lowers the recognition efficiency.

In summary, the prior art has the problem that the single-area handwriting input method has a lower efficiency in recognizing multiple handwritten trails entered all at once. It is therefore imperative to provide a better solution.

### SUMMARY OF THE INVENTION

In view of the foregoing, the invention disclosed a multi-area handwriting input system and the method thereof.

The disclosed multi-area handwriting input system is used in an electronic device with the handwriting recognition function. It includes: a displaying module for displaying a display interface with a first input area, a second input area, and a candidate words display area, and for displaying the candidate words in the candidate words display area; a receiving module for receiving a first handwritten trail entered by a pointer signal in the first input area, and for receiving a second handwritten trail entered by a pointer signal in the second input area; and a recognizing module pre-stored with at least one word and at least one set of combined words, and for obtaining at least one first candidate word according to the first handwritten trail, assigning a first display order number to each of the first candidate words, and triggering the displaying module to display the first candidate words in the candidate words display area. When the receiving module receives the selection signal of selecting one of the first candidate word as an input word, the recognizing module triggers the displaying module to clear the candidate words display area and the first input area. When the receiving module receives the second handwritten trail, the recognizing module obtains at least one second candidate word, and assigns a second display order number to each of the second candidate words. When the candidate words display area does not clear the first candidate words, the recognizing module determines whether there is at least one set of combined words as a combination of the first candidate words and the second candidate words. If there is at least one set of combined words, the recognizing module triggers the displaying module to display at least one set of combined words in the candidate words display area for selection as input words. If no combined words exist, then the recognizing module uses the first candidate word of the highest priority in the first display order numbers as an input word, and triggers the displaying module to display the second candidate words in the candidate words display area for selection as an input word.

The disclosed multi-area handwriting input method is used in electronic devices with the handwriting recognition function. The method includes the steps of: providing a first input area, a second input area, and a candidate words display area in a display interface; receiving a first handwritten trail entered by a pointer signal in the first input area; recognizing the first handwritten trail and extracting at least one first candidate word; displaying the first candidate words in the candidate words display area, wherein each of the first candidate words having a corresponding first display order number; when a selection signal of selecting one of the first candidate words as an input word is received, clearing the candidate words display area and the first input area; receiving a second handwritten trail entered by the pointer signal in the second input area; recognizing the second handwritten trail and extracting at least one second candidate word, wherein each of the second candidate words having a corresponding second display order number; when the candidate words display area does not clear the first candidate words, determining whether there is at least one set of combined words as a combination of the first candidate words and the second candidate words; if there is at least one set of combined words, displaying at least one set of combined words in the candidate words display area for selection as input words; and if there is no possible combined words, using the first candidate word with the highest priority in the first display order numbers as an input word and displaying at least one second candidate word in the candidate words display area for selection as an input word.

Using the disclosed techniques, the invention can increase the recognition efficiency in handwriting input.

### BRIEF DESCRIPTION OF THE DRAWINGS

The invention will become more fully understood from the detailed description given herein below illustration only, and thus is not limitative of the present invention, and wherein:

FIG. 1 is a block diagram of the disclosed multi-area handwriting input system;

FIG. 2 is a flowchart of the disclosed multi-area handwriting input method; and

FIGS. 3A to 3C are schematic view of inputting words through the display interface via handwriting recognition according to an embodiment of the invention.

### DETAILED DESCRIPTION OF THE INVENTION

The present invention will be apparent from the following detailed description, which proceeds with reference to the accompanying drawings, wherein the same references relate to the same elements.

Those Chinese characters shown in the drawings are just mentioned for describing the embodiments and are substantially irrelevant to any technical matters.

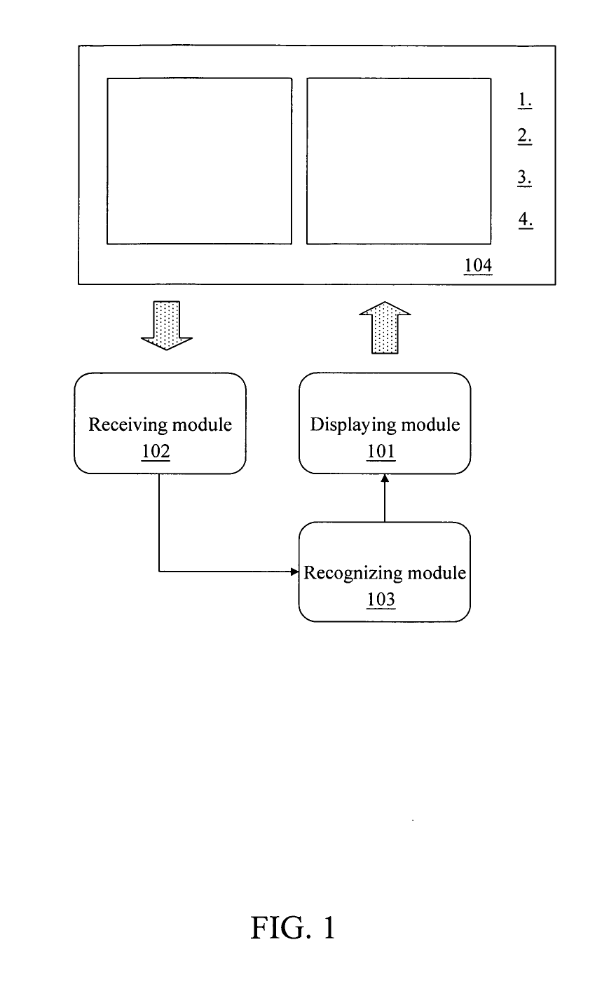

First, please refer to FIG. 1. The disclosed multi-area handwriting input system includes a displaying module 101, a receiving module 102, and a recognizing module 103. The system is suitable for electronic devices with the handwriting recognition function. The electronic device referred herein can be a handheld device with the touch-control handwriting function, a touch-control panel, or any other device with the handwriting recognition function.

The displaying module 101 shows the display interface as shown in the display interface schematic view 104 of FIG. 1. The display interface is provided with a first input area, a second input area, and a candidate words display area. The first input area and the second input area are basic blocks for handwritten trail input and recognition. When a user enters a handwritten trail in any of the input areas, the receiving module 102 sends the received handwritten trail to the recognizing module 103 for recognition. When the recognizing module 103 obtains candidate words according to handwritten trails, the candidate words are displayed by the displaying module 101 in the candidate words display area for the user to select as an input word.

In addition to the first input area, the second input area, and the candidate words display area, the displaying area further includes at least one function triggering link. The function triggering links can be a symbol table, language switches, space bar, delete, cancel, restore, etc. These are only some examples. Any triggering link for function extensions should be covered by the invention.

The receiving module 102 receives the first handwritten trail enter by the pointer signal in the first input area and receives the second handwritten trail enter by the pointer signal in the second input area. It should be mentioned that the pointer signal refers to the moving signal of the mouser cursor or the touch-control device. While in some electronic devices the display interface may use the mouse cursor to enter a handwritten trail, in some other electronic devices the handwritten trails may otherwise use a touch-control pen or user's fingers to enter a handwritten trail without a mouse cursor. Therefore, the pointer signal mentioned herein refers to any moving signal that can be used to generate a handwritten trail.

The recognizing module 103 pre-stores at least one word and at least one set of combined words. After the receiving module 102 receives the first handwritten trail, the recognizing module 103 uses the stored words and combined words to obtain first candidate words. Each of the first candidate words is assigned with a first display order number. Afterwards, the displaying module 101 is triggered to display the candidate words in the candidate words display area.

When the receiving module 102 receives a selection signal of selecting one of the first candidate words as an input word, the recognizing module 103 triggers the displaying module 101 to clear the candidate words display area and the first input area. It should be noted that the selection signal is produced when the user makes a selection or the user does not make any selection within a certain time interval, wherein the time interval is used to determine whether a long pause occurs during user's input process and can be predetermined by the system or set by the user.

When the receiving module 102 further receives the second handwritten trail, the recognizing module 103 uses the stored words and combined words to obtain at least one second candidate word. Each of the second candidate words is assigned with a second display order number. When the candidate words display area does not clear the first candidate words, it means that no first candidate word is selected as an input word. In this case, the recognizing module 103 determines whether there is at least one set of combined words as a combination of the first candidate words and the second candidate words. If there is at least one set of combined words, the recognizing module 103 triggers the displaying module 101 to display at least one set of combined words in the candidate words display area for selection as the input words. On the other hand, if no possible combined words exist, then the handwritten trails entered by the user in the first input area and the second input area are considered as individual inputs. The recognizing module 103 then uses the first candidate word with the highest priority in the first display order number as an input word, and then triggers the displaying module 101 to display at least one second candidate word in the candidate words display area for selection as an input word.

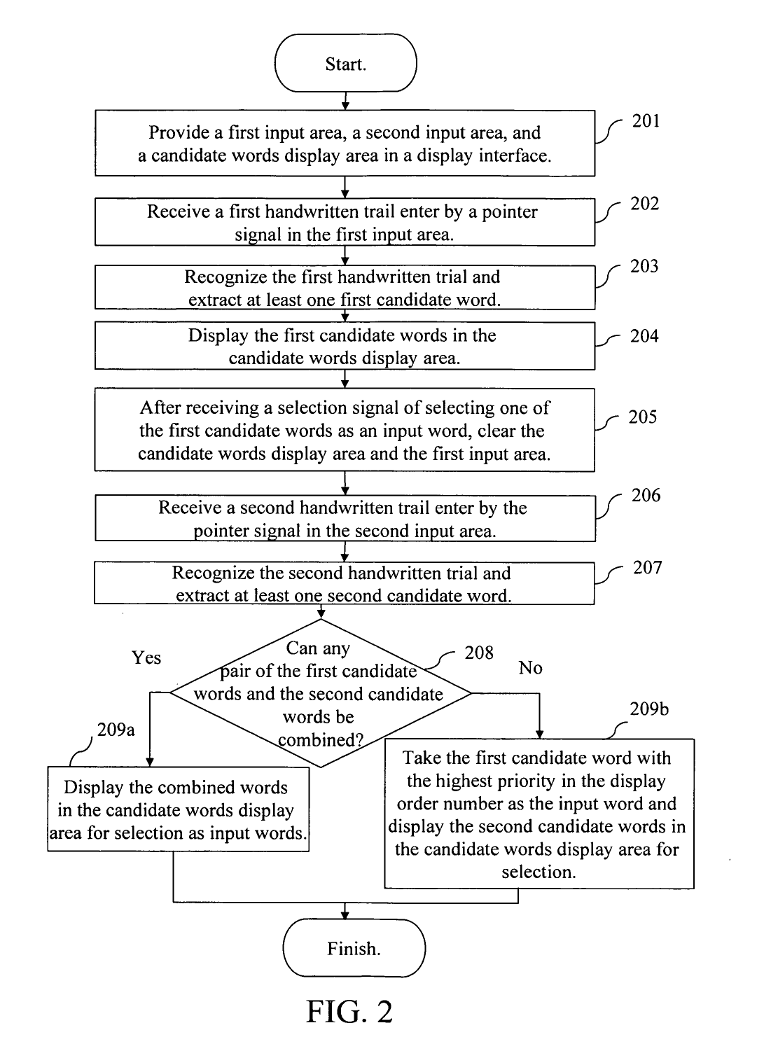

Please refer to FIG. 2 for a flowchart of the disclosed multi-area handwriting input method. It shows the steps to implement the invention.

The disclosed multi-area handwriting input method is suitable for electronic devices with the handwriting recognition function. The electronic device referred herein can be a handheld device with the touch-control handwriting function, a touch-control panel, or any other device with the handwriting recognition function.

First, the method provides a first input area, a second input area, and a candidate words display area in a display interface (step 201). The first input area and the second input area are basic blocks for recognizing handwritten trails. They both have the same handwritten trail recognition function. In one embodiment, the first input area and the second input area can be used for input alternately, thereby increasing the smoothness of inputting multiple handwritten trails. Suppose a user wants to enter three words. He can enter the handwritten trail of the first word in the first input area. While the first word is being recognized, he enters the second word in the second input area. While the second word is being recognized, the user goes back to the first input area to enter the third word. Therefore, the user can enter multiple handwritten trails at a time, and each of the input areas is only responsible for recognizing a single word. There is no need to divide the handwritten trail into multiple words. The alternating input method between the first input area and the second input area is only one example. In practice, the first input area and the second input area can adopt some other alternating method to increase the input smoothness. Moreover, although two input areas are assumed throughout the specification, there can be more input areas in practice. The invention does not put any restriction on the number of input areas.

The candidate words display area is used to display candidate words when the electronic device receives candidate words recognized from the handwritten trail. In addition to the first input area, the second input area, and the candidate words display area, the display area further includes at least one function triggering link. The function triggering links can be a symbol table, language switches, space bar, delete, cancel, restore, etc. Although several possible examples of function triggering links are mentioned, any triggering link with function extensions is covered by the invention.

Afterwards, the method receives the first handwritten trail entered by the pointer signal in the first input area (step 202). The pointer signal refers to the moving signal of the mouser cursor or the touch-control device. While in some electronic devices the display interface may use the mouse cursor to enter a handwritten trail, in some other electronic devices the handwritten trails may otherwise use a touch-control pen or user's fingers to enter a handwritten trail without a mouse cursor. Therefore, the pointer signal mentioned herein refers to any moving signal that can be used to generate a handwritten trail.

When the electronic device receives the first handwritten trail in the first input area, it immediately recognizes the first handwritten trail and extracts at least one first candidate word (step 203). At least one first candidate word is then shown in the candidate words display area (step 204). Each of the first candidate words has a first display order number for batch display and input selection.

When the signal of selecting one of the first candidate words as an input word is received, the candidate words display area and the first input area are cleared (step 205). It should be noted that the selection signal is produced when the user makes a selection or the user does not make any selection within a certain time interval, wherein the time interval is used to determine whether a long pause occurs during user's input process and can be predetermined by the system or set by the user.

If the user enters the first handwritten trail and selects one of the first candidate words as an input word, then this stage of word input is completed. Since no candidate word is needed for reference, the candidate words display area and the first input area will then be cleared. When the method afterwards receives the second handwritten trail entered by the pointer signal in the second input area (step 206), the second handwritten trail is recognized to obtain at least one second candidate word (step 207). The method then determines whether the first candidate words and the second candidate words can be combined in any way (step 208). Likewise, each of the second candidate words has a corresponding second display order number.

The highest priority in the first display order number refers to the largest order number, the smallest order number, or the largest or smallest order number in same display batch. Since different methods have different determinations in the priority order, the invention does not restrict what can be used to determine the highest priority in the order numbers. Before displaying second candidate words, if the first candidate words in the candidate words display area are not cleared, then it means that the user has not determined which word to input. In this case, each of the first candidate words and each of the second candidate words are combined to form sets of combined words. They are then compared with the database containing candidate combined words. If there are matches, then the candidate words display area shows all possible combined words for selection as input words (step 209a). Otherwise, the first candidate word with the highest priority in display order number is used as an input word, and the candidate words display area shows second candidate words for selection (step 209b).

In the following, a handheld electronic device implemented with the invention is used as an embodiment to explain how the invention works. Although the handwritten trails illustrated hereinafter using Chinese characters and Chinese words as examples, the invention does not restrict the language adopted by the handwriting recognition. It should be noted that since Chinese uses characters as handwritten recognition units whereas English uses words as handwritten recognition units, each Chinese characters described hereinafter is functionally equivalent to single English words and each Chinese words described hereinafter is functionally equivalent to multiple English words.

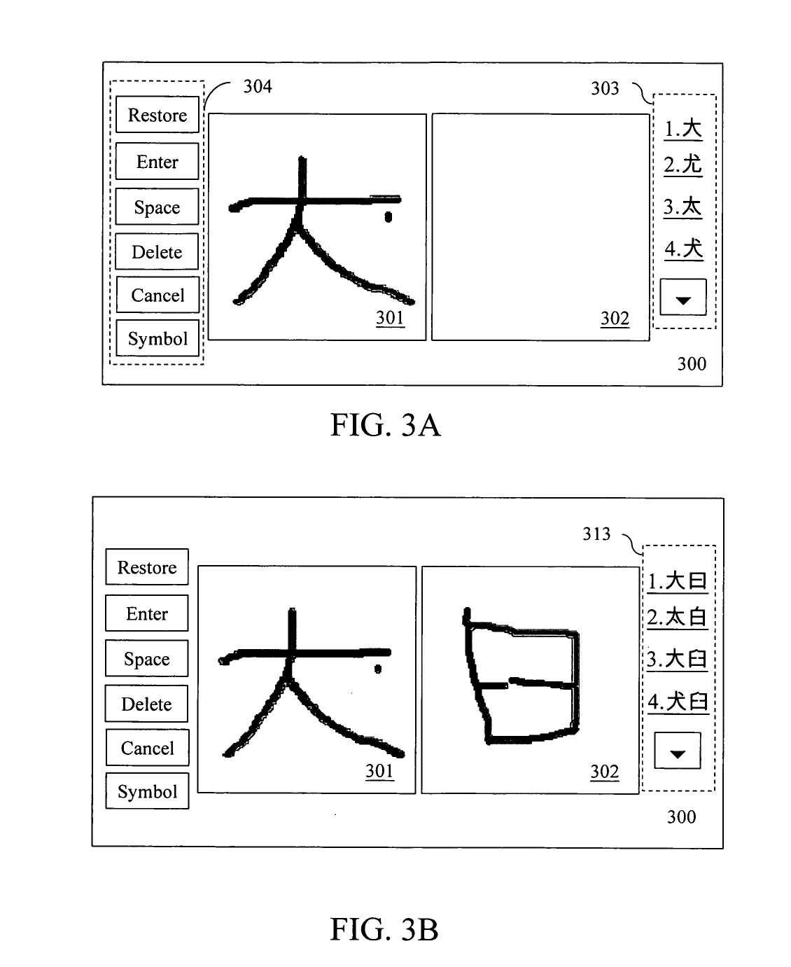

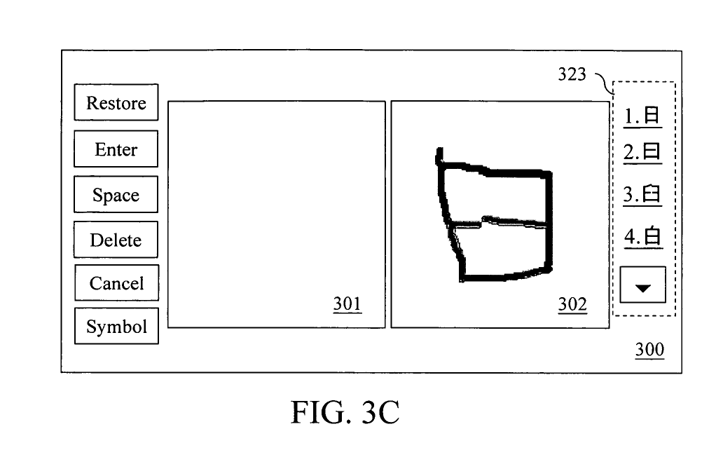

Please refer to FIG. 3A. First, the display interface 300 of the handwriting input provides a first input area 301, a second input area 302, and a candidate words display area 303. In addition, the display interface 300 can further include at least one function triggering link 304. After the user enters the first handwritten trail in the first input area 301, the electronic device starts to recognize the first handwritten trail and extract possible first candidate words (not shown). Each of the first candidate words has a display order number for batch display and input selection. It should be mentioned that the pointer signal refers to the moving signal of the mouse cursor or the touch-control device. While in some electronic devices the display interface may use the mouse cursor to enter a handwritten trail, in some other electronic devices the handwritten trails may otherwise use a touch-control pen or user's fingers to enter a handwritten trail without a mouse cursor. Therefore, the pointer signal mentioned herein refers to any moving signal that can be used to generate a handwritten trail.

Suppose the user selects one of the candidate words in the candidate words display area 303 as an input word, the candidate words display area 303 is cleared.

Afterwards, suppose the user enters a second handwritten trail in the second input area 302, the electronic device will then recognize the second handwritten trail and extracts the corresponding second candidate words (not shown). Likewise, each of the second candidate words has a corresponding second display order number. When the first candidate words in the candidate words display area 303 are not cleared, it means that that user has not determined the first input word. Suppose the first candidate words (illustrated as Chinese characters) are shown in the candidate words display area 303, and the second candidate words (also in Chinese characters but not shown) were generated. Since the first candidate words in the candidate words display area 303 are not cleared, all possible combined words formed from the first candidate words and the second candidate words will be compared with the stored combined words in the database. If there are matches, then the combined words (illustrated as Chinese words) will be displayed in the candidate words display area 313. If no combined word exists, then the two candidate words are considered as individual word inputs. The default first candidate word, for example, the first Chinese character within candidate words display area 303 of FIG. 3A, is used as the input word. The invention then shows the second candidate words (illustrated as Chinese characters) for the user to select, as those shown in the candidate words display area 323 in FIG. 3C.

In summary, the invention differs from the prior art in that it has multiple input areas for receiving handwritten trails. According to the single words recognized from individual input areas, the invention determines possible combined words for the user to select as inputs. The disclosed technique can solve problems existing in the prior art. The invention thus enhances the efficiency in handwriting recognition.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A multi-area handwriting input system for an electronic device with handwriting recognition, comprising:
a displaying module for displaying a display interface with a first input area, a second input area, and a candidate words display area, and for displaying candidate words in the candidate words display area;
a receiving module for receiving a first handwritten trail entered by a pointer signal in the first input area, and for receiving a second handwritten trail entered by the pointer signal in the second input area; and
a recognizing module pre-stored with at least one word and at least one set of combined words, and for obtaining at least one first candidate word according to the first handwritten trail, assigning a first display order number to each of the first candidate words, and triggering the displaying module to show the first candidate words in the candidate words display area; wherein
when the receiving module receives a selection signal of selecting one of the first candidate words as an input word, the recognizing module triggers the displaying module to clear the candidate words display area and the first input area;
when the receiving module receives the second handwritten trail, the recognizing module obtains at least one second candidate word according to the second handwritten trail and assigns a second display order number to each of the second candidate words; and
when the candidate words display area does not clear the first candidate words, the recognizing module determines whether one of the first candidate words and one of the second candidate words form a set of combined words; wherein
if at least one set of combined words exists, then the recognizing module triggers the displaying module to display the combined words in the candidate words display area for selection as input words; and
if no combined words exist, then the recognizing module takes the first candidate word with the highest priority in the first display order number as an input word and triggers the displaying module to show the second candidate words in the candidate words display area for selection as an input word.

2. The multi-area handwriting input system for an electronic device with handwriting recognition of claim 1, wherein the pointer signal is a moving signal of the mouse cursor or touch-control device.

3. The multi-area handwriting input system for an electronic device with handwriting recognition of claim 1, wherein the displaying module shows at least one function triggering link in the display interface.

4. The multi-area handwriting input system for an electronic device with handwriting recognition of claim 1, wherein the selection signal is produced when the user makes a selection or the user does not make any selection within a time interval.

5. The multi-area handwriting input system for an electronic device with handwriting recognition of claim 4, wherein the time interval is predetermined by the system or set by the user.

6. A multi-area handwriting input method for an electronic device with handwriting recognition, comprising the steps of:
providing a first input area, a second input area, and a candidate words display area in a display interface;
receiving a first handwritten trail entered by a pointer signal in the first input area;
recognizing the first handwritten trail and extracting at least one first candidate word;
displaying the first candidate words in the candidate words display area, wherein each of the first candidate words having a corresponding first display order number;
when receiving a selection signal of selecting one of the first candidate words as an input word, clearing the candidate words display area and the first input area;
receiving a second handwritten trail entered by the pointer signal in the second input area;
recognizing the second handwritten trail and extracting at least one second candidate word, wherein each of the second candidate words having a corresponding second display order number; and
when the candidate words display area does not clear the first candidate words, determining whether one of the first candidate words and one of the second candidate words form a set of combined words; wherein
if at least one set of combined words exists, then the combined words are displayed in the candidate words display area for selection as input words; and
if no combined words exist, then the first candidate word with the highest priority in the first display order number is used as an input word and the second candidate words are displayed in the candidate words display area for selection as an input word.

7. The multi-area handwriting input method for an electronic device with handwriting recognition of claim 6, wherein the pointer signal is a moving signal of the mouse cursor or touch-control device.

8. The multi-area handwriting input method for an electronic device with handwriting recognition of claim 6, wherein the displaying module shows at least one function triggering link in the display interface.

9. The multi-area handwriting input method for an electronic device with handwriting recognition of claim 6, wherein the selection signal is produced when the user makes a selection or the user does not make any selection within a time interval.

10. The multi-area handwriting input method for an electronic device with handwriting recognition of claim 9, wherein the time interval is predetermined by the system or set by the user.
